(19) United States
(12) Patent Application Publication
(10) Pub. No.: US 2020/0300250 A1
(43) Pub. Date: Sep. 24, 2020

(54) Centrifugal Pump

(71) Applicant: AISAN KOGYO KABUSHIKI KAISHA, Obu-shi, Aichi-ken (JP)

(72) Inventors: Hidemasa TORII, Anjo-shi, Aichi-ken (JP); Keiji NAKAYA, Nisshin-shi, Aichi-ken (JP)

(73) Assignee: AISAN KOGYO KABUSHIKI KAISHA, Obu-shi, Aichi-ken (JP)

(21) Appl. No.: 16/763,241

(22) PCT Filed: Nov. 19, 2018
(86) PCT No.: PCT/JP2018/042599

§ 371 Date: May 12, 2020

(30) Foreign Application Priority Data
Nov. 20, 2017 (JP) 2017-222615

(51) Int. Cl. F04D 13/06; F04D 29/46; F04D 29/58

(52) U.S. Cl. CPC F04D 13/068; F04D 29/46; F05D 2250/52; F05D 2250/51; F04D 29/5806

(57) ABSTRACT

A centrifugal pump includes a pump and a motor. The pump includes an impeller configured to forcibly transfer a fluid and defines a pump chamber housing the impeller therein. The motor includes a hollow rotational shaft configured to rotate the impeller, and a casing defining a motor chamber that houses the rotational shaft therein. The rotational shaft forms a discharge passage therein and has a first end engaged with the impeller and a second end where a first end of the discharge passage opens. The first end of the discharge passage is in fluid communication with a low pressure area in the pump chamber via a second end of the discharge passage and is in fluid communication with a high pressure area in the pump chamber via an introduction passage formed in the casing.

### CROSS-REFERENCE TO RELATED APPLICATIONS

The present application is a National Phase entry of, and claims to the benefit of, PCT Application No. PCT/JP2018/042599 filed Nov. 19, 2018, which claims priority to Japanese Patent Application No. 2017-222615 filed Nov. 20, 2017, each of which is incorporated herein by reference in its entirety for all purposes.

### STATEMENT REGARDING FEDERALLY SPONSORED RESEARCH OR DEVELOPMENT

Not applicable.

### BACKGROUND

The disclosure generally relates to centrifugal pumps.

One type of a centrifugal pump has a pump and a motor (see, e.g. Japanese Laid-Open Patent Publication No. 2017-61919). The pump includes an impeller configured to forcibly transfer a fluid and defines a pump chamber for housing the impeller therein. The motor includes a rotational shaft engaged with the impeller. The centrifugal pump forcibly feeds the fluid, due to the rotation of the impeller caused by the operation of the motor. In Japanese Laid-Open Patent Publication No. 2017-61919, an outward surface of a casing is provided with a plurality of fins, and the rotational shaft of the motor has a cooling fan. Due to this configuration, the casing is cooled by exposing the fins to the air from the cooling fan, thereby suppressing an increase in the temperature of the motor.

### SUMMARY

In one aspect of this disclosure, a centrifugal pump includes a pump and a motor. The pump includes an impeller for forcibly transferring a fluid and forms a pump chamber for housing the impeller therein. The motor includes a rotational shaft and a casing defining a motor chamber that houses the rotational shaft therein. The rotational shaft is hollow and is configured to rotate the impeller. The rotational shaft defines a discharge passage therein and has a first end engaged with the impeller and a second end where one end of the discharge passage opens. The one end of the discharge passage is in fluid communication with a low pressure area in the pump chamber via the other end of the discharge passage and is in fluid communication with a high pressure area in the pump chamber via an introduction passage formed by the casing

In accordance with this aspect, embodiments described herein offer the potential to improve the cooling performance of the motor of the centrifugal pump, thereby suppressing deterioration and reduction in strength of the components of the motor.

### BRIEF DESCRIPTION OF THE DRAWINGS

FIG. 1 is a cross-sectional view of a first embodiment of a centrifugal pump in accordance with the principles described herein.

FIG. 2 is an enlarged partial cross-sectional view of the centrifugal pump of FIG. 1 schematically illustrating a fluid flow in a principal part thereof.

FIG. 3 is an enlarged partial cross-sectional view of a principal part of a second embodiment of a centrifugal pump in accordance with the principles described herein.

FIG. 4 is an enlarged cross-sectional view of a spiral groove of a rotational shaft of a third embodiment of a centrifugal pump in accordance with the principles described herein.

FIG. 5 is an enlarged partial cross-sectional view of a principal part of a fourth embodiment of a centrifugal pump.

FIG. 6 is a cross-sectional view of a flow control valve of the centrifugal pump of FIG. 5 at a low temperature.

FIG. 7 is a cross-sectional view of the flow control valve of the centrifugal pump of FIG. 5 at a high temperature.

### DETAILED DESCRIPTION

As previously described, Japanese Laid-Open Patent Publication No. 2017-61919 disclosing a casing that may be cooled by exposing fins to air from the cooling fan. However, the interior of the motor is hardly cooled. Accordingly, components of the motor may deteriorate or lose strength. Therefore, there has been a need for improved centrifugal pumps.

Embodiments will be described below with reference to drawings.

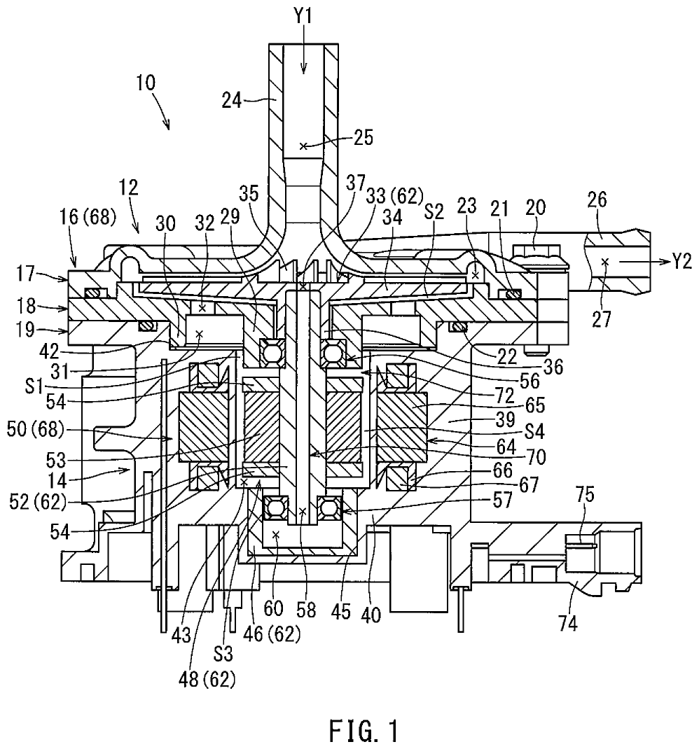

A first embodiment of a centrifugal pump 10 that is used as a purge pump is shown in FIG. 1. Centrifugal pump 10 can be mounted on a vehicle, such as an automobile, and may be configured to make up for an insufficient amount of a purge flow from a canister to an intake passage of an internal combustion engine (also referred to as an engine). FIG. 1 is a cross-sectional view of the centrifugal pump 10. Although upward, downward, rightward, and leftward directions of the centrifugal pump 10 are defined based on FIG. 1, these directions do not limit installation orientations of the centrifugal pump on the vehicle.

As illustrated in FIG. 1, the centrifugal pump 10 includes a pump 12 and a motor 14. The pump 12 and the motor 14 are aligned in an axial direction (the vertical direction) along a rotational shaft 52 that will be described later. A casing 16, corresponding to an outer shell structure of the centrifugal pump 10, is divided into three parts, including a first casing part 17, a second casing part 18, and a third casing part 19 generally arranged one on top of the other in the axial direction (the vertical direction in FIG. 1). The first casing part 17, the second casing part 18, and the third casing part 19 are fastened to each other by a plurality of bolts 20 or the like. A first O-ring 21 is disposed between the first casing part 17 and the second casing part 18 for sealing therebetween. A second O-ring 22 is disposed between the second casing part 18 and the third casing part 19 for sealing therebetween.

The first casing part 17 and the second casing part 18 form a pump casing for the pump 12. The first casing part 17 and the second casing part 18 define a pump chamber 23 having a hollow disk shape. The first casing part 17 includes an inlet port 24 having a hollow cylindrical shape extending axially outward (upward in FIG. 1). The inlet port 24 defines an inlet passage 25 allowing fluid communication between the interior and the exterior of the pump chamber 23. The first casing part 17 includes an outlet port 26 having a hollow cylindrical shape. The outlet port 26 extends in a direction tangential to a circle that is formed along an outer periphery of a base plate 34 of an impeller 33, which will be described later, in the rightward direction in FIG. 1. The outlet port 26 defines an outlet passage 27 allowing fluid communication between the interior and the exterior of the pump chamber 23.

An inner cylindrical part 29 and an outer cylindrical part 30, each having a hollow cylindrical shape, are formed at a lower surface of the second casing part 18. The outer cylindrical part 30 is coaxially aligned with the inner cylindrical part 29 disposed within the outer cylindrical part 30. The inner cylindrical part 29 defines a through-hole extending along the axial direction. The inner cylindrical part 29 and the outer cylindrical part 30 form an annular space 31 therebetween. The second casing part 18 has introduction holes 32, each of which is a through hole penetrating the second casing part 18 in the vertical direction. Each of the introduction holes 32 is in fluid communication with the annular space 31. The introduction holes 32 are uniformly circumferentially spaced.

The impeller 33 is housed in the pump chamber 23 of the pump 12. The impeller 33 includes the base plate 34 having a circular plate shape, a plurality of blades 35 uniformly circumferentially spaced on an upper surface of the base plate 34, and a boss 36 having a hollow cylindrical shape coaxially formed with and located at a lower surface of the base plate 34. The impeller 33 is rotatably disposed in the pump chamber 23. The boss 36 is rotatably inserted into the inner cylindrical part 29 of the second casing part 18. A discharge hole 37, which is a through-hole having a smaller diameter than an inner diameter of the boss 36, is formed at a central portion of the base plate 34. The discharge hole 37 is positioned near the inlet passage 25, which corresponds to a lower pressure area of the pump chamber 23.

The motor 14 may be a brushless motor configured to rotate the impeller 33. The second casing part 18 and the third casing part 19 form a motor casing for the motor 14. The third casing part 19 has a hollow cylindrical shape with a closed bottom. The third casing part 19 includes a cylindrical wall 39 having a hollow cylindrical shape, and a bottom wall 40 closing a lower opening of the cylindrical wall 39. A step-shaped recessed part 42 is formed at an inner periphery of an upper end surface of the cylindrical wall 39. The outer cylindrical part 30 of the second casing part 18 is fitted into the step-shaped recessed part 42. A lower end surface of the outer cylindrical part 30 is positioned away from a bottom surface of the step-shaped recessed part 42 by a predetermined distance.

The second casing part 18 and the third casing part 19 define a motor chamber 43. The motor chamber 43 is in fluid communication with the pump chamber 23 via the annular space 31 and the introduction holes 32 of the second casing part 18. A lower end portion of the inner cylindrical part 29 of the second casing part 18 is loosely inserted into an inner circumferential surface of the cylindrical wall 39 of the third casing part 19. The inner cylindrical part 29 and the cylindrical wall 39 define a predetermined gap, which is referred to as a first space S1, between mutually facing surfaces thereof in the radial direction. A support recessed part 45 having a hollow cylindrical shape with a closed bottom is coaxially formed with and located at the bottom wall 40 of the third casing part 19. A retainer 46 having a hollow cylindrical shape with a closed bottom is provided in the support recessed part 45.

The motor 14 includes a rotor 48, a stator 50, and other components. The rotor 48 includes the rotational shaft 52 and permanent magnets 53. The rotational shaft 52 comprises of a hollow shaft. The permanent magnets 53 are disposed at a center portion of the rotational shaft 52, such that a plurality of magnetic poles are arranged in the circumferential direction. The permanent magnets 53 are positioned by a pair of upper and lower positioning plates 54 fixed to the rotational shaft 52.

The rotor 48 is housed in the motor chamber 43. An end part, i.e. an upper end part of the rotational shaft 52 is rotatably supported in the inner cylindrical part 29 of the second casing part 18 via a bearing, which is referred to as a first bearing 56. The first bearing 56 may be a ball bearing including an inner ring fixed to the rotational shaft 52 and an outer ring fixed in the inner cylindrical part 29 of the second casing part 18. The boss 36 of the impeller 33 is supported on the inner ring of the first bearing 56. Due to this, the base plate 34 of the impeller 33 and the second casing part 18 define a predetermined gap, which is referred to as a second space S2, between mutually facing surfaces thereof in the axial direction. The upper end part of the rotational shaft 52 extends through the first bearing 56. An upper end of the rotational shaft 52 is inserted into, i.e. engaged with the boss 36 of the impeller 33 in an integrally rotatable manner.

The other end part, i.e. a lower end part, of the rotational shaft 52 is rotatably supported in the retainer 46 of the third casing part 19 via a bearing, which is referred to as a second bearing 57. The second bearing 57 may be a barrel-shaped ball bearing including an inner ring fixed on the rotational shaft 52 and an outer ring loosely fitted into the retainer 46. Thus, the retainer 46 and the outer ring of the second bearing 57 form a predetermined gap, which is referred to as a third space S3, between mutually facing surfaces thereof in the radial direction. A hollow inner space 58 of the rotational shaft 52 is in fluid communication with the discharge hole 37 of the impeller 33. A communication chamber 60, which is in fluid communication with both the hollow inner space 58 of the rotational shaft 52 and the third space S3, is formed in a lower part of the retainer 46. The one end part, i.e. the upper end part, of the rotational shaft 52 may be herein referred to as a first end part. The other end part, i.e. the lower end part, of the rotational shaft 52 may be herein referred to as a second end part.

The rotational shaft 52 of the rotor 48 extends axially, i.e. vertically, within the casing 16. The rotor 48 is capable of rotating about the central axis of the rotational shaft 52 in the casing 16. The impeller 33 rotates with the rotor 48. The rotor 48 and the impeller 33 are collectively referred to as a rotation unit 62.

The stator 50 includes a core 64. The core 64 includes a core body 65, coils 67 wound around the core body 65, and a bobbin 66 disposed between the core body 65 and the coils 67. The core body 65 is composed of a plurality of core plates stacked axially, i.e. vertically. The bobbin 66 is made from a resin material. The core 64 is entirely covered with a resin layer, which forms the cylindrical wall 39 of the third casing part 19. The core 64 is axially aligned and radially opposed to the permanent magnets 53 of the rotor 48. A combination of the casing 16, the retainer 46, and the stator 50 may be referred to as a fixed unit 68.

The cylindrical wall 39 of the third casing part 19 and the rotor 48 define a predetermined gap, which is referred to as a fourth space S4, between mutually facing surfaces thereof in the radial direction. The fourth space S4 is in fluid communication with the third space S3.

The hollow inner space 58 of the rotational shaft 52 and the discharge hole 37 of the impeller 33 form a discharge passage 70. The discharge passage 70 is formed in the rotation unit 62 such that one end of the discharge passage 70 opens at an end part of the rotational shaft 52, which is opposite to the impeller 33, i.e. a lower end part, and that the other end of the discharge passage 70 opens at the low pressure area in the pump chamber 23.

The introduction holes 32 of the second casing part 18, the annular space 31, the first space S1, the fourth space S4, the third space S3 in the motor chamber 43, and the communication chamber 60 collectively define an introduction passage 72. The introduction passage 72 is formed in the motor chamber 43 of the fixed unit 68, such that one end thereof opens at a high pressure area in the pump chamber 23 and that the other end is in fluid communication with the other end of the discharge passage 70.

A control circuit (not shown), which provides power feed control to the motor 14, is disposed in a lower part of the third casing part 19. The third casing part 19 has a connector 74. A terminal 75 linked to the control circuit is disposed in the connector 74. An external connector (not shown) coupled to an external power source (not shown), such as a battery mounted on the vehicle, is connected to the connector 74. The control circuit receives electric power from the external power source and supplies it to the motor 14.

The motor 14 is driven by power supplied from the external power source. As a result, the rotor 48 is rotated such that the rotation unit 62, including the impeller 33, is rotated so as to forcibly move the fluid. More specifically, the fluid, i.e. a purge gas in this embodiment is suctioned into the pump chamber 23 via the inlet passage 25 due to rotation of the impeller 33 (see an arrow Y1 in FIG. 1). The fluid is pressurized in the pump chamber 23 by rotation of the impeller 33, and then is discharged from the outlet passage 27 (see an arrow Y2 in FIG. 1). At this time, in the pump chamber 23, the pressure of the fluid on the downstream side, i.e. the outlet passage 27 side is higher than that on the upstream side, i.e. the inlet passage 25 side. In other words, differential pressure is generated in the pump chamber 23. An area near the inlet passage 25 of the pump chamber 23 corresponds to the low pressure area in this disclosure. An outer circumferential area of the pump chamber 23 corresponds to the high pressure area in this disclosure.

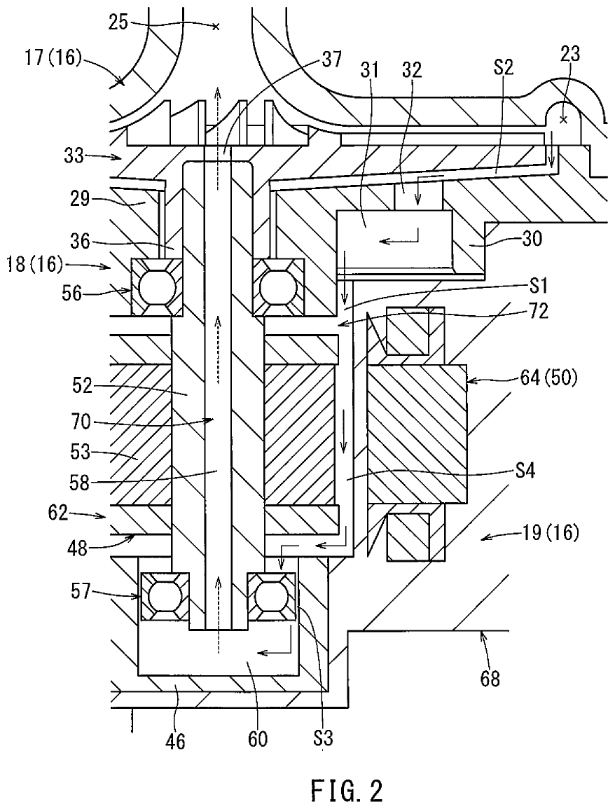

Due to the differential pressure generated in the pump chamber 23, a part of the fluid in the pump chamber 23 is introduced from the high pressure area in the pump chamber 23 into the introduction passage 72 through the second space S2. Then, the fluid flows through the discharge passage 70 and is discharged into the low pressure area in the pump chamber 23. More specifically, the fluid in the second space S2 of the pump chamber 23 flows through the introduction holes 32, the annular space 31, the first space S1, the fourth space S4, and the third space S3 of the introduction passage 72 into the communication chamber 60 (see the solid arrows in FIG. 2). Then, the fluid in the communication chamber 60 flows through the hollow inner space 58 and the discharge hole 37 of the discharge passage 70 into the low pressure area in the pump chamber 23 (see the dot line arrows in FIG. 2).

A part of the fluid in the second space S2 flows toward the fourth space S4 via a radial gap between the inner cylindrical part 29 of the second casing part 18 and the boss 36 of the impeller 33 and a gap between components of the first bearing 56, such as a space between the inner ring and the outer ring, a space between the inner ring and the balls, and a space between the outer ring and the balls. A part of the fluid in the fourth space S4 flows toward the communication chamber 60 via a gap between components of the second bearing 57 such as a space between the inner ring and the outer ring, a space between the inner ring and the balls, and a space between the outer ring and the balls.

In accordance with the centrifugal pump 10 of the first embodiment, the fluid flowing through both the introduction passage 72 and the discharge passage 70 absorbs heat from both the fixed unit 68 and the rotation unit 62 of the motor 14. The heat is then transferred to the fluid in the low pressure area of the pump chamber 23. As a result, the cooling performance of the motor 14 can be improved, thereby suppressing deterioration and a reduction in strength of the components of the motor 14.

The fluid flowing through the fourth space S4 between the rotor 48 and the fixed unit 68 can efficiently cool mutually facing portions of both the rotor 48 and the fixed unit 68.

The fluid flowing through the hollow inner space 58 of the rotational shaft 52 can efficiently cool the rotational shaft 52 from the inside.

The fluid flowing through the third space S3 between the retainer 46 and the second bearing 57 can efficiently cool the second bearing 57.

The fluid flowing through the gap between the components of the first bearing 56 can efficiently cool the first bearing 56. The fluid flowing through the gap between the components of the second bearing 57 can efficiently cool the second bearing 57.

The cooling performance for the motor 14 is improved, so that heat stresses at peripheral parts of the bearings 56, 57 can be decreased. Accordingly, a failure risk of the motor 14 due to heat can be decreased. An increase in the resistance of the coils 67 of the stator 50 can be suppressed, thereby inhibiting a decrease in motor efficiency. A decrease in the life of the motor 14 caused by heat deterioration thereof can be suppressed, thereby increasing the life of the centrifugal pump 10.

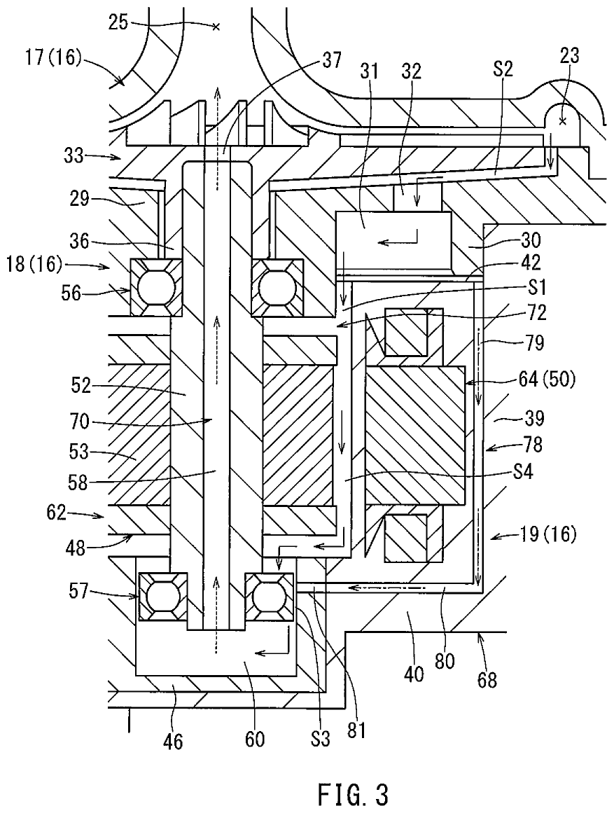

A second embodiment of a centrifugal pump similar to centrifugal pump 10 shown in FIG. 1 with some differences is shown in FIG. 3. The differences will be described, and repetitive explanations will be omitted. FIG. 3 is the cross-sectional view of a principal part of the second embodiment of the centrifugal pump. As illustrated in FIG. 3, a bypass passage 78 bypassing the fourth space S4 is formed in the fixed unit 68. The bypass passage 78 includes a longitudinal passage 79, a transverse passage 80, and a communication hole 81. The longitudinal passage 79 and the transverse passage 80 are formed in the third casing part 19. The communication hole 81 is formed in the retainer 46.

The longitudinal passage 79 is formed in the cylindrical wall 39 of the third casing part 19, so as to extend in the longitudinal direction, i.e. the vertical direction, near the radially outer portion of the stator 50. One end part, i.e. an upper end part, of the longitudinal passage 79 opens at a bottom surface of the step-shaped recessed part 42, and thus, is in fluid communication with the annular space 31 via an axial gap between the outer cylindrical part 30 of the second casing part 18 and the step-shaped recessed part 42. The transverse passage 80 is formed in the bottom wall 40 of the third casing part 19 to extend near a lower portion of the stator 50 in the horizontal direction, in particular the radial direction of the bottom wall 40. One end part, i.e. an outer end part, of the transverse passage 80 is in fluid communication with the other end part, i.e. a lower end part, of the longitudinal passage 79. The communication hole 81 is formed in the retainer 46 to allow fluid communication between the other end part, i.e. an inner end part of the transverse passage 80 and the third space S3. The third casing part 19 may be referred to herein as “a wall of a casing.” The bypass passage 78 may be referred to herein as “a part of an introduction passage.”

In accordance with the second embodiment, a part of the fluid in the annular space 31 flows toward the third space S3 via the bypass passage 78 (see the dash-dot line arrows in FIG. 3). Accordingly, the fluid flowing through the bypass passage 78 can efficiently cool the stator 50.

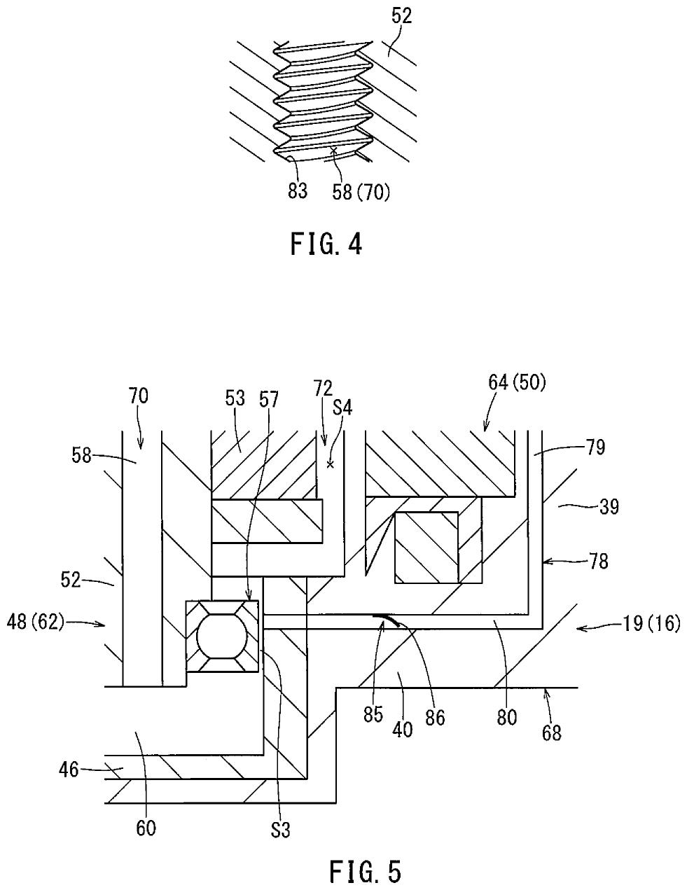

A third embodiment of a centrifugal pump similar to centrifugal pump 10 shown in FIG. 1 with some differences is shown in FIG. 4. The differences will be described, and repetitive explanations will be omitted. FIG. 4 is a cross-sectional view of a spiral groove of the rotational shaft. As illustrated in FIG. 4, a spiral groove 83 like a screw groove is formed on an inner facing surface of the rotational shaft 52. The inner facing surface of the rotational shaft 52 corresponds to a wall surface defining the hollow inner space 58. A winding direction of the spiral groove 83 is set as a direction capable of promoting a fluid flow, by using the rotation of the rotation unit 62.

In accordance with the third embodiment, the spiral groove 83 of the rotational shaft 52 can promote fluid flow through the hollow inner space 58 by using the rotation of the rotational shaft 52. Thus, the amount of the fluid flowing through the discharge passage 70 and the introduction passage 72 (see FIG. 1) is increased, thereby improving the cooling performance for the motor 14. The spiral groove 83 may also be formed on an inner circumferential surface of the discharge hole 37 of the impeller 33.

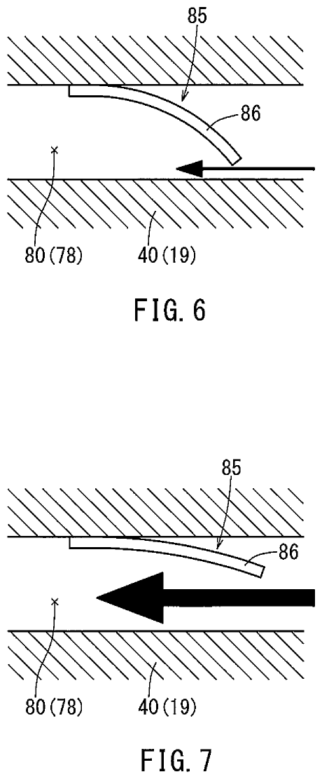

A fourth embodiment of a centrifugal pump similar to centrifugal pump shown in FIG. 3 with some differences is shown in FIG. 5. The differences will be described, and repetitive explanations will be omitted. As illustrated in FIG. 5, the transverse passage 80 of the bypass passage 78 is provided with a bimetallic type valve 85 configured to control a size of a passage area depending on the fluid temperature. The bimetallic type valve 85 may use extension/contraction of bimetallic member 86 depending on temperature changes so as to control the size of the passage area. The bimetallic member 86 is a plate having an arc-shape, such that one end, i.e. a base end, of the bimetallic member 86 is fixedly engaged with a passage wall surface of the transverse passage 80 of the bypass passage 78, i.e. the bottom wall 40 of the third casing part 19. When the bimetallic member 86 contracts at lower temperatures, the bimetallic type valve 85 decreases the size of the passage area (see FIG. 6). When the bimetallic member 86 extends at higher temperatures, the bimetallic type valve 85 increases the size of the passage area (see FIG. 7). The bimetallic type valve 85 may be herein referred to as “flow control valve” or “temperature-sensitive flow control valve.”

In accordance with the fourth embodiment, the bimetallic type valve 85, which is configured to control the size of the passage area depending on the fluid temperature, decreases the size of the passage area of the transverse passage 80 of the bypass passage 78 at lower temperatures (see FIG. 6). Thus, the bimetallic type valve 85 reduces the amount of fluid flowing therethrough. Accordingly, a decrease in pump efficiency can be suppressed at lower temperatures. The size of the passage area of the transverse passage 80 of the bypass passage 78 is increased at higher temperatures (see FIG. 7), so that the amount of fluid flowing therethrough is also increased. Accordingly, the cooling performance for the motor 14 can be improved at higher temperatures.

The bimetallic type valve 85 may alternatively be provided in the longitudinal passage 79 of the bypass passage 78. The bimetallic type valve 85 may alternatively be disposed in the introduction passage 72 or the discharge passage 70. Other temperature-sensitive flow control valves, such as a bellows valve, a wax valve or the like, may be used instead of the bimetallic type valve 85. The flow control valve may be composed of an electromagnetic flow control valve instead of the temperature-sensitive flow control valve.

The aspects disclosed herein are not limited to the above-described embodiments and can be carried out in other various embodiments. For example, the centrifugal pump 10 may be used as a pump for forcibly transferring a variety of fluids, e.g. gases, such as air, or liquids, such as water or fuel, other than the above described purge gas. The centrifugal pump 10 is not limited to the above described purge pump and may be used as a water pump configured to circulate cooling water for an internal combustion engine. The brushless motor of the motor 14 may be replaced with a brushed motor.

Various configurations of the aspects are disclosed herein. A first configuration is a centrifugal pump including a pump and a motor. The pump includes an impeller for forcibly transferring a fluid and forms a pump chamber housing the impeller therein. The motor includes a hollow rotational shaft configured to rotate the impeller and a casing defining a motor chamber that houses the rotational shaft therein. The rotational shaft defines a discharge passage therein and has a first end engaged with the impeller and a second end where one end of the discharge passage opens. The one end of the discharge passage is in fluid communication with a low pressure area in the pump chamber via the other end of the discharge passage. The one end of the discharge passage is in fluid communication with a high pressure area in the pump chamber via an introduction passage formed by the casing.

In accordance with the first configuration, the impeller of the pump is rotated due to being driven by the motor, so as to forcibly transfer the fluid. At that time, due to differential pressure generated in the pump chamber, a part of the fluid in the high pressure area of the pump chamber is introduced into the introduction passage. The part of the fluid then flows through the discharge passage, and then is discharged into the low pressure area. Accordingly, the fluid flowing through both the introduction passage and the discharge passage absorbs heat from the motor, in particular the casing and a peripheral area around the rotational shaft. The fluid then transmits the heat to the fluid in the low pressure area of the pump chamber. Consequently, the cooling performance of the motor can be improved, thereby suppressing deterioration and a reduction in strength of the components of the motor.

A second configuration corresponds to the centrifugal pump of the first configuration. The motor includes a rotor. A part of the introduction passage is an empty space between the rotor and the casing.

In accordance with the second configuration, the fluid flowing through the empty space between the rotor and the casing can efficiently cool mutually facing portions of the rotor and the casing.

A third configuration corresponds to the centrifugal pump of the first configuration or the second configuration. The motor includes a stator. The casing includes a wall covering the stator. A part of the introduction passage is formed in the wall.

In accordance with the third configuration, the fluid flowing in the wall of the casing covering the stator can efficiently cool the stator.

A fourth configuration corresponds to the centrifugal pump of any one of the first to third configurations. An inner circumferential surface of the discharge passage has a spiral groove promoting a fluid flow therethrough by using a rotation of the rotational shaft.

In accordance with the fourth configuration, the spiral groove promotes the fluid flow by using the rotation of the rotational shaft. Accordingly, the amount of the fluid flowing through both the discharge passage and the introduction passage can be increased, thereby improving the cooling performance of the motor.

A fifth configuration corresponds to the centrifugal pump of any one of the first to fourth configurations. At least one of the introduction passage and the discharge passage includes a flow control valve configured to control a size of a passage area depending on a fluid temperature.

In accordance with the fifth configuration, due to the flow control valve configured to control the passage area depending on the fluid temperature, the size of the passage area is decreased when the fluid temperature is low, such that the flow amount is also reduced. Accordingly, a decrease in pump efficiency can be suppressed. However, when the fluid temperature is high, the size of the passage area is increased, such that the flow amount is also increased. Accordingly, a cooling performance for the motor can be improved.

1. A centrifugal pump, comprising:
a pump including an impeller for forcibly transferring a fluid, wherein the pump forms a pump chamber for housing the impeller therein; and
a motor including a rotational shaft and a casing defining a motor chamber that houses the rotational shaft therein, wherein the rotational shaft is hollow and is configured to rotate the impeller, wherein:
the rotational shaft defines a discharge passage therein and has a first end engaged with the impeller and a second end where a first end of the discharge passage opens;
the first end of the discharge passage is in fluid communication with a low pressure area in the pump chamber via an second end of the discharge passage and is in fluid communication with a high pressure area in the pump chamber via an introduction passage formed by the casing;
a first end of the introduction passage opens at the casing to face the impeller and is in fluid communication with the first end of the discharge passage via a second end of the introduction passage;
the introduction passage includes, between the first end and the second end of the introduction passage, a first passage and a second passage bypassing the first passage;
each of the first passage and a second passage and the second passage of the introduction passage is in fluid communication with the high pressure area in the pump chamber via the first end of the introduction passage and is in fluid communication with the discharge passage via the second end of the introduction passage;
the motor includes a rotor and a stator;
the first passage is defined by the rotor and the casing;
the casing includes a wall covering the stator; and
the second passage is formed in the wall of the casing.

2. (canceled)

3. (canceled)

4. The centrifugal pump of claim 1, wherein an inner circumferential surface of the discharge passage has a spiral groove capable of promoting a fluid flow therethrough due to rotation of the rotational shaft.

5. The centrifugal pump of claim 1, wherein at least one of the introduction passage and the discharge passage includes a flow control valve configured to control a size of a passage area depending on a temperature of the fluid.
